(19) United States
(12) Patent Application Publication
(10) Pub. No.: US 2026/0299729 A1
(43) Pub. Date: Oct. 1, 2026

(54) DISPLAY DEVICE

(71) Applicant: LG Display Co., Ltd., Seoul (KR)

(72) Inventor: JuneGun Chung, Paju-si, Gyeonggi-do (KR)

(73) Assignee: LG Display Co., Ltd., Seoul (KR)

(21) Appl. No.: 19/396,736

(22) Filed: Nov. 21, 2025

(30) Foreign Application Priority Data
Mar. 25, 2025 (KR) 10-2025-0037711

(51) Int. Cl. G06F 3/041; G06F 3/044; G09G 3/36

(52) U.S. Cl. CPC G06F 3/04184; G06F 3/04164; G09G 3/3696; G06F 3/0412; G06F 3/044; G09G 2354/00

(57) ABSTRACT

According to embodiments of the present disclosure, a display device includes a first serial clock signal transmitted from a touch controller to a first read-out integrated circuit, the first serial clock signal having a signal level change at a first time point, and a second serial clock signal transmitted from the touch controller to a second read-out integrated circuit, the second serial clock signal having a signal level change at a second time point different from the first time point. Accordingly, touch signals can be transmitted stably.

### CROSS REFERENCE TO RELATED APPLICATION

This application claims priority from Korean Patent Application No. 10-2025-0037711, filed on Mar. 25, 2025, which is hereby incorporated by reference for all purposes as if fully set forth herein.

### TECHNICAL FIELD

Embodiments of the present disclosure relate to a display device.

### BACKGROUND

As the information-oriented society has developed, the demand for display devices for displaying images has increased in various forms, and recently, various display devices such as liquid crystal display devices and organic light-emitting display devices have been utilized.

### SUMMARY

Embodiments of the present disclosure may provide a display device in which, as a result of changing a type of a signal, signal interference that may occur between signals can be prevented or reduced.

Embodiments of the present disclosure may provide a display device in which, as signal interference is prevented, reduced, or minimized, touch sensing data can be stably transmitted to a touch controller.

Embodiments of the present disclosure may provide a display device capable of low power consumption by stably transmitting a signal.

The objects of the embodiments of the present disclosure are not limited to those mentioned herein, and other objects not mentioned can be clearly understood by those skilled in the art from the following description.

Accordingly one or more embodiments of the present disclosure, a display device may include: a display panel on which a plurality of sub-pixels and a plurality of touch electrodes are disposed; a first read-out integrated circuit electrically connected to a first touch electrode; a second read-out integrated circuit electrically connected to a second touch electrode; a touch controller electrically connected to the first read-out integrated circuit and the second read-out integrated circuit and receiving touch sensing data from the first read-out integrated circuit and the second read-out integrated circuit; a first serial clock signal transmitted from the touch controller to the first read-out integrated circuit and having a signal level change at a first time point; and a second serial clock signal transmitted from the touch controller to the second read-out integrated circuit and having a signal level change at a second time point different from the first time point.

According to one or more embodiments of the present disclosure, by changing a type of a signal, signal interference that may occur between signals can be prevented or reduced in a display device.

According to one or more embodiments of the present disclosure, as signal interference is prevented, reduced, or minimized, touch sensing data can be stably transmitted to a touch controller in a display device.

According to one or more embodiments of the present disclosure, by stably transmitting a signal, a display device capable of low power consumption can be provided.

The effects of the embodiments of the present disclosure are not limited to the effects mentioned herein, and additional effects not mentioned can be clearly understood by those skilled in the art from the following description or may be learned by practicing the present disclosure.

### BRIEF DESCRIPTION OF THE DRAWINGS

The present disclosure can be more fully understood from the following detailed description and the accompanying drawings. The detailed description and drawings are provided for illustrative purposes only and are not intended to limit the scope of the present specification.

FIG. 1 is a block diagram of a display driving system of a touch display device according to example embodiments of the present disclosure.

FIG. 2 illustrates a touch sensing system of a touch display device according to example embodiments of the present disclosure.

FIG. 3 more specifically illustrates the touch sensing system according to example embodiments of the present disclosure.

FIG. 4 is a diagram briefly illustrating a communication relationship between a touch controller and a read-out integrated circuit according to example embodiments of the present disclosure.

FIG. 5 illustrates a read-out integrated circuit constituting a touch driving circuit of the touch sensing system according to example embodiments of the present disclosure.

FIG. 6 is a diagram briefly illustrating a communication relationship between a touch controller and a read-out integrated circuit according to example embodiments of the present disclosure.

FIG. 7 is a diagram illustrating a signal for driving a touch controller and a read-out integrated circuit according to example embodiments of the present disclosure.

FIG. 8 is a diagram illustrating a method in which a read-out integrated circuit transmits data to a touch controller according to example embodiments of the present disclosure.

FIG. 9 is a diagram illustrating types of serial clock signals according to example embodiments of the present disclosure.

FIG. 10 is a driving timing diagram including a serial clock signal according to embodiments of the present disclosure.

FIG. 11, FIG. 12, and FIG. 13 illustrate patterns of serial clock signals according to example embodiments of the present disclosure.

FIG. 14 is a driving timing diagram including a serial clock signal according to example embodiments of the present disclosure.

### DETAILED DESCRIPTION

In the following description of examples or embodiments of the present disclosure, reference will be made to the accompanying drawings in which it is shown by way of illustration specific examples or embodiments that can be implemented. The same reference numerals and signs may be used to designate the same or like components even when they are shown in different drawings. Further, in the following description of examples or embodiments of the present disclosure, detailed descriptions of well-known functions and components incorporated herein may be omitted when such detailed descriptions may make the subject matter in one or more example embodiments of the present disclosure rather unclear.

Such terms as “including”, “having”, “containing”, “constituting”, “make up of”, and “formed of” used herein are generally intended to allow other components to be added unless the terms are used with a more specific term like “only”. As used herein, singular forms are intended to include plural forms, and vice versa, unless the context clearly indicates otherwise.

Terms, such as “first”, “second”, “A”, “B”, “(A)”, or “(B)”, may be used herein to describe elements of the present disclosure. Each of these terms is not used to define essence, order, sequence, or number of elements, etc., but is used merely to refer to the corresponding element separately from other elements.

Where the specification describes that a first element “is connected or coupled to” or “contacts or overlaps” a second element, it should be interpreted that, not only can the first element “be directly connected or coupled to” or “directly contact or overlap” the second element, but a third element can also be “interposed” between the first and second elements, or the first and second elements can “be connected or coupled to” or “contact or overlap” each other via a fourth element. Here, the second element may be included in at least one of two or more elements that “are connected or coupled to” or “contact or overlap” each other.

Where time relative terms, such as “after,” “subsequent to,” “next,” “before,” and the like, are used to describe processes or operations of elements or configurations, or flows or steps in operating, processing, or manufacturing methods, these terms may be used to describe non-consecutive or non-sequential processes or operations unless a more specific term like “directly” or “immediately” is used together.

In addition, where any dimensions, relative sizes, etc., are mentioned, it should be considered that numerical values for elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can”.

Hereinafter, various example embodiments of the present disclosure will be described in detail with reference to the accompanying drawings.

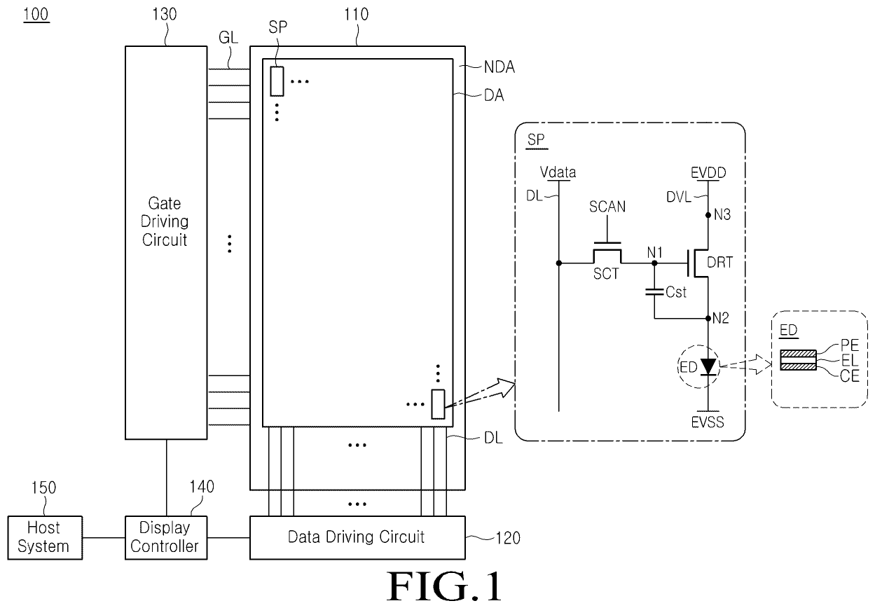

FIG. 1 is a diagram illustrating a display driving system of a touch display device 100 according to example embodiments of the present disclosure.

As shown in FIG. 1, the display driving system of the touch display device 100 according to embodiments of the present disclosure may include a display panel 110 and a display driving circuit for driving the display panel 110.

The display panel 110 may include a display area DA in which an image is displayed, and a non-display area NDA in which an image is not displayed.

The display panel 110 may include a plurality of sub-pixels SP for displaying an image. For example, the plurality of sub-pixels SP may be disposed in the display area DA. In some cases, at least one sub-pixel SP may be disposed in the non-display area NDA. The at least one sub-pixel SP disposed in the non-display area NDA may be a dummy sub-pixel.

The display panel 110 may include a plurality of signal lines for driving the plurality of sub-pixels SP. For example, the plurality of signal lines may include a plurality of data lines DL and a plurality of gate lines GL. The signal lines may further include other signal lines in addition to the plurality of data lines DL and the plurality of gate lines GL depending on a structure of the sub-pixel SP. For example, the other signal lines may include driving voltage lines DVL.

The plurality of data lines DL and the plurality of gate lines GL may intersect each other. Each of the plurality of data lines DL may be disposed to extend in a first direction. Each of the plurality of gate lines GL may be disposed to extend in a second direction. The first direction may be a column direction, and the second direction may be a row direction. In the present specification, the column direction and the row direction are relative. For example, the column direction may be a vertical direction, and the row direction may be a horizontal direction. In another example, the column direction may be a horizontal direction, and the row direction may be a vertical direction.

The display driving circuit may include a data driving circuit 120 for driving the plurality of data lines DL and a gate driving circuit 130 for driving the plurality of gate lines GL. The display driving circuit may further include a display controller 140 for controlling the data driving circuit 120 and the gate driving circuit 130.

The data driving circuit 120 is a circuit for driving the plurality of data lines DL, and may output data voltages (data signals) corresponding to an image signal to the plurality of data lines DL.

The gate driving circuit 130 is a circuit for driving the plurality of gate lines GL, and may generate gate signals and output the gate signals to the plurality of gate lines GL.

The display controller 140 may start scanning according to timing implemented in each frame, and may control data driving at an appropriate time in accordance with the scanning. The display controller 140 may convert input image data input from outside into a data signal format used by the data driving circuit 120, and may supply the converted image data to the data driving circuit 120.

The display controller 140 may receive display driving control signals from a host system 150 together with the input image data. For example, the display driving control signals may include a vertical sync signal (VSYNC), a horizontal sync signal (HSYNC), an input data enable signal (DE: Data Enable), and a clock signal.

The display controller 140 may generate data driving control signals and gate driving control signals based on the display driving control signals (e.g., VSYNC, HSYNC, DE, and clock signal) input from the host system 150. The data driving control signals and the gate driving control signals may be control signals included in the display driving control signals.

The display controller 140 may control a driving operation and driving timing of the data driving circuit 120 by supplying the data driving control signals to the data driving circuit 120. For example, the data driving control signals may include a source start pulse (SSP), a source sampling clock (SSC), and a source output enable signal (SOE).

The display controller 140 may control a driving operation and driving timing of the gate driving circuit 130 by supplying the gate driving control signals to the gate driving circuit 130. For example, the gate driving control signals may include a gate start pulse (GSP), a gate shift clock (GSC), and a gate output enable signal (GOE).

The data driving circuit 120 may include one or more source driver integrated circuits (SDICs). Each source driver integrated circuit SDIC may include a shift register, a latch circuit, a digital-to-analog converter (DAC), and an output buffer. Each source driver integrated circuit SDIC may further include an analog-to-digital converter (ADC) in some cases.

For example, each source driver integrated circuit SDIC may be connected to the display panel 110 by a tape automated bonding (TAB) method, connected to a bonding pad of the display panel 110 by a chip-on-glass (COG) or chip-on-panel (COP) method, or implemented by a chip-on-film (COF) method and connected to the display panel 110.

The gate driving circuit 130 may output a gate signal of a turn-on level voltage or a gate signal of a turn-off level voltage under the control of the display controller 140. The gate driving circuit 130 may sequentially drive the plurality of gate lines GL by sequentially supplying the gate signal of the turn-on level voltage to the plurality of gate lines GL.

The gate driving circuit 130 may be connected to the display panel 110 by a tape automated bonding (TAB) method, connected to a bonding pad of the display panel 110 by a chip-on-glass (COG) or chip-on-panel (COP) method, or connected to the display panel 110 by a chip-on-film (COF) method. Alternatively, the gate driving circuit 130 may be formed in the non-display area NDA of the display panel 110 as a gate-in-panel (GIP) type. The gate driving circuit 130 may be disposed on a substrate or connected to a substrate. That is, when the gate driving circuit 130 is of the GIP type, it may be disposed in the non-display area NDA of the substrate. When the gate driving circuit 130 is of the COG type or the COF type, it may be connected to the substrate.

Meanwhile, at least one of the data driving circuit 120 and the gate driving circuit 130 may be disposed in the display area DA. For example, at least one of the data driving circuit 120 and the gate driving circuit 130 may be disposed so as not to overlap the sub-pixels SP, or may be disposed to partially or entirely overlap the sub-pixels SP.

When a specific gate line GL is driven by the gate driving circuit 130, the data driving circuit 120 may convert the image data received from the display controller 140 into a data voltage Vdata in an analog form and supply the data voltage to the plurality of data lines DL.

The data driving circuit 120 may be connected to one side (e.g., an upper side or a lower side) of the display panel 110. Depending on a driving method and a panel design method, the data driving circuit 120 may be connected to both sides (e.g., an upper side and a lower side) of the display panel 110, or may be connected to two or more sides among four sides of the display panel 110.

The gate driving circuit 130 may be connected to one side (e.g., a left side or a right side) of the display panel 110. Depending on a driving method and a panel design method, the gate driving circuit 130 may be connected to both sides (e.g., a left side and a right side) of the display panel 110, or may be connected to two or more sides among four sides of the display panel 110.

The display controller 140 may be implemented as a separate component from the data driving circuit 120, or may be integrated with the data driving circuit 120 and implemented as an integrated circuit.

The display controller 140 may be a timing controller used in conventional display technology, may be a control device including the timing controller and further performing other control functions, may be a control device different from the timing controller, or may be a circuit within a control device. The display controller 140 may be implemented with various circuits or electronic components such as an integrated circuit (IC), a field programmable gate array (FPGA), an application specific integrated circuit (ASIC), or a processor.

The display controller 140 may be mounted on a printed circuit board, a flexible printed circuit, or the like, and may be electrically connected to the data driving circuit 120 and the gate driving circuit 130 through the printed circuit board, the flexible printed circuit, or the like.

The display controller 140 may transmit and receive signals to and from the data driving circuit 120 according to one or more predetermined interfaces. For example, the interface may include an LVDS (Low Voltage Differential Signaling) interface, an EPI interface, or an SPI (Serial Peripheral Interface). The display controller 140 may include one or more storage media such as registers.

The touch display device 100 according to embodiments of the present disclosure may be a self-emissive display device in which the display panel 110 emits light by itself. When the touch display device 100 according to embodiments of the present disclosure is a self-emissive display device, each of a plurality of sub-pixels SP may include a light-emitting device ED.

For example, the touch display device 100 according to embodiments of the present disclosure may be an organic light-emitting display device in which the light-emitting device ED is implemented as an organic light-emitting diode. In another example, the touch display device 100 according to embodiments of the present disclosure may be an inorganic light-emitting display device in which the light-emitting device ED is implemented as an inorganic light-emitting diode. In still another example, the touch display device 100 according to embodiments of the present disclosure may be a quantum dot display device in which the light-emitting device ED is implemented as a quantum dot, which is a semiconductor crystal that emits light by itself.

As shown in FIG. 1, in the touch display device 100 according to example embodiments of the present disclosure, each sub-pixel SP may include a light-emitting device ED, a driving transistor DRT for controlling a current flowing through the light-emitting device ED, a scan transistor SCT for delivering a data voltage Vdata corresponding to an image signal to the driving transistor DRT, and a storage capacitor Cst for maintaining a voltage for a predetermined period of time.

The light-emitting device ED may include a pixel electrode PE, a common electrode CE, and an emitting layer EL disposed between the pixel electrode PE and the common electrode CE. The light-emitting device ED may be, for example, one of an organic light-emitting diode, an inorganic light-emitting diode, and a quantum dot light-emitting device.

The common electrode CE of the light-emitting device ED may be a cathode electrode. A base voltage EVSS may be applied to the common electrode CE of the light-emitting device ED. For example, the base voltage EVSS may be a ground voltage or a voltage similar to the ground voltage.

The driving transistor DRT is a transistor for driving the light-emitting device ED, and may include a first node N1, a second node N2, and a third node N3.

The first node N1 of the driving transistor DRT may be a gate node, and may be electrically connected to a source node or a drain node of the scan transistor SCT.

The second node N2 of the driving transistor DRT may be a source node or a drain node, and may be electrically connected to the pixel electrode PE of the light-emitting device ED.

The third node N3 of the driving transistor DRT may be a drain node or a source node, and a driving voltage EVDD may be applied thereto. The third node N3 of the driving transistor DRT may be electrically connected to a driving voltage line DVL supplying the driving voltage EVDD.

The scan transistor SCT may control a connection between the first node N1 of the driving transistor DRT and a corresponding data line DL according to a scan signal SCAN supplied from a gate line GL.

A drain node or a source node of the scan transistor SCT may be electrically connected to the corresponding data line DL. A source node or a drain node of the scan transistor SCT may be electrically connected to the first node N1 of the driving transistor DRT. A gate node of the scan transistor SCT may be electrically connected to the gate line GL to receive the scan signal SCAN.

The scan transistor SCT may be turned on by the scan signal SCAN of a turn-on level voltage to deliver the data voltage Vdata supplied from the corresponding data line DL to the first node N1 of the driving transistor DRT.

The scan transistor SCT may be turned on by the scan signal SCAN of the turn-on level voltage, and may be turned off by the scan signal SCAN of a turn-off level voltage. When the scan transistor SCT is of an n-type, the turn-on level voltage may be a high-level voltage, and the turn-off level voltage may be a low-level voltage. When the scan transistor SCT is of a p-type, the turn-on level voltage may be a low-level voltage, and the turn-off level voltage may be a high-level voltage.

The storage capacitor Cst may be electrically connected between the first node N1 and the second node N2 of the driving transistor DRT to maintain the data voltage Vdata corresponding to the image signal voltage, or a voltage corresponding thereto, for one frame period.

The storage capacitor Cst may be an external capacitor intentionally designed outside the driving transistor DRT, rather than a parasitic capacitor (e.g., Cgs, Cgd) which is an internal capacitor existing between the first node N1 and the second node N2 of the driving transistor DRT.

For example, each of the driving transistor DRT and the scan transistor SCT may be an n-type transistor or a p-type transistor. The driving transistor DRT and the scan transistor SCT may both be n-type transistors or both be p-type transistors. At least one of the driving transistor DRT and the scan transistor SCT may be an n-type transistor (or a p-type transistor), and the other may be a p-type transistor (or an n-type transistor).

The structure of each sub-pixel SP illustrated in FIG. 1 is merely an example for explanation, and each sub-pixel SP may include one or more transistors or may further include one or more capacitors. Each of the plurality of sub-pixels SP may have the same structure, or some of the plurality of sub-pixels SP may have different structures.

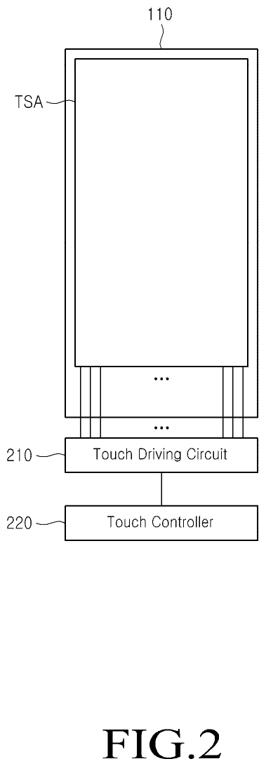

FIG. 2 is a diagram illustrating a touch sensing system of the touch display device 100 according to example embodiments of the present disclosure.

As shown in FIG. 2, the touch display device 100 according to example embodiments of the present disclosure may include, in addition to an image display function, a touch sensing system for sensing occurrence of a touch by a touch pointer or sensing a touch position by the touch pointer.

For example, the touch pointer may be a user's touch tool, and may include a finger or a pen. The touch display device 100 may sense, as touch coordinates, a position where the touch pointer is in contact with the display panel 110. When the touch pointer is close to the display panel 110 without being in contact with the display panel 110, the touch display device 100 may sense, as touch coordinates, a position of the proximate touch pointer.

The touch sensing system may include a touch sensor disposed in a touch sensing area TSA, and a touch circuit for driving and sensing the touch sensor to sense whether a touch is made and/or a touch position.

The touch circuit may include a touch driving circuit 210 and a touch controller 220. The touch driving circuit 210 may drive and sense the touch sensor, and may generate and output touch sensing data according to a sensing result.

The touch controller 220 may recognize whether a touch has occurred by using the touch sensing data provided from the touch driving circuit 210 or may calculate touch coordinates. The touch controller 220, or another controller interlocked therewith, may perform a predetermined function (e.g., input processing, object selection processing, handwriting processing, etc.) based on the recognized touch occurrence or the calculated touch position.

The touch sensor may be included inside or outside the display panel 110.

When the touch sensor is included inside the display panel 110, the touch sensor may be formed during a manufacturing process of the display panel 110. When the touch sensor is included inside the display panel 110, the touch sensor may be referred to as an embedded touch sensor. For example, the embedded touch sensor may include an in-cell type touch sensor or an on-cell type touch sensor.

When the touch sensor is included outside the display panel 110, a touch panel including the touch sensor and the display panel 110 may be separately manufactured, and the touch panel and the display panel 110 may be bonded together. For example, the external touch sensor may include an add-on type touch sensor.

Hereinafter, for convenience of explanation, it is assumed that the touch sensor is included inside the display panel 110. However, the present disclosure is not limited thereto.

The touch sensor may be disposed in the touch sensing area TSA. A position and/or a size of the touch sensing area TSA may correspond to a position and/or a size of the display area DA. In some cases, the position and/or the size of the touch sensing area TSA may be different from the position and/or the size of the display area DA.

The touch sensor may include a plurality of touch electrodes. The touch sensor may further include a plurality of touch routing wirings for electrically connecting the plurality of touch electrodes to the touch driving circuit 210.

Depending on whether a user touches the touch sensor, at least one electrical state (e.g., capacitance) of the plurality of touch electrodes may change. The touch driving circuit 210 may sense a change in the electrical state of the touch electrode through at least one of the plurality of touch routing wirings.

The touch driving circuit 210 may be implemented as an integrated circuit separate from the data driving circuit 120. Alternatively, the touch driving circuit 210 and the data driving circuit 120 may be integrated into one and implemented as an integrated circuit.

The touch controller 220 may be implemented separately from the display controller 140 or may be integrated with the display controller 140.

The touch sensing system of the touch display device 100 according to embodiments of the present disclosure may sense a touch based on self-capacitance or may sense a touch based on mutual-capacitance.

Hereinafter, for convenience of explanation, it is assumed that the touch sensing system of the touch display device 100 according to embodiments of the present disclosure senses a touch based on self-capacitance.

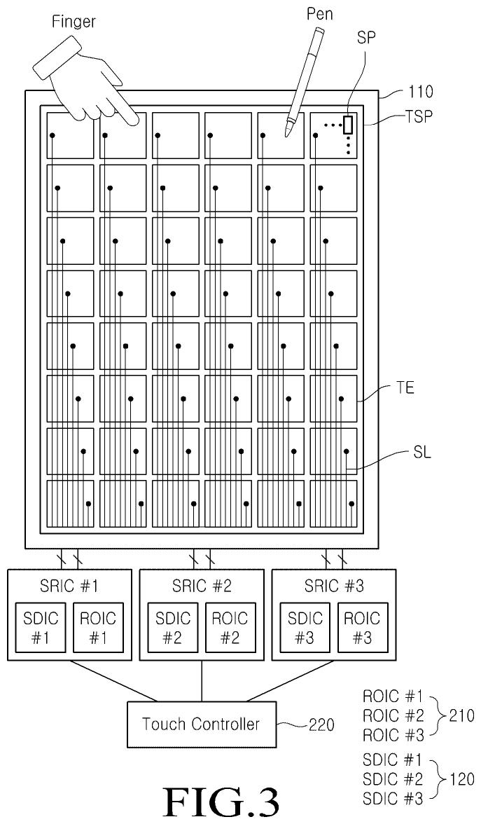

FIG. 3 more specifically illustrates the touch sensing system according to example embodiments of the present disclosure.

As shown in FIG. 3, the touch panel TSP may include a touch sensor, and the touch sensor may include a plurality of touch electrodes TE. The touch panel TSP may include a plurality of signal lines SL for electrically connecting the plurality of touch electrodes TE to the touch driving circuit 210.

When the touch sensor is an external touch sensor existing outside the display panel 110, the touch panel TSP may be manufactured separately from the display panel 110 and may be combined with the display panel 110.

When the touch sensor is an embedded touch sensor existing inside the display panel 110, during manufacturing of the display panel 110, a plurality of touch electrodes TE and a plurality of signal lines SL in the touch panel TSP may be formed together in a process in which other display-related electrodes or wirings of the display panel 110 are formed on a substrate of the display panel 110.

As shown in FIG. 3, to drive all or some of the plurality of touch electrodes TE, the touch driving circuit 210 may supply a touch driving signal to all or some of the plurality of touch electrodes TE.

The touch driving circuit 210 may detect a touch sensing signal from all or some of the plurality of touch electrodes TE to sense all or some of the plurality of touch electrodes TE.

The touch driving circuit 210 may generate and output touch sensing data according to detection of the touch sensing signal. T he touch sensing data may include sensing values for all or some of the plurality of touch electrodes TE.

The touch controller 220 may determine whether a touch input is made or may calculate touch coordinates by using the touch sensing data provided from the touch driving circuit 210.

For example, the touch controller 220 may be implemented as a micro controller unit (MCU). The touch driving circuit 210 may be implemented as one or more read-out integrated circuits (ROICs).

In the example of FIG. 3, the touch driving circuit 210 may include a first read-out integrated circuit (ROIC #1), a second read-out integrated circuit (ROIC #2), and a third read-out integrated circuit (ROIC #3).

In addition, in the example of FIG. 3, the data driving circuit 120 may include a first source driver integrated circuit (SDIC #1), a second source driver integrated circuit (SDIC #2), and a third source driver integrated circuit (SDIC #3).

In addition, in the example of FIG. 3, the first read-out integrated circuit ROIC #1 and the first source driver integrated circuit SDIC #1 may be integrated and implemented as a first source read-out integrated circuit (SRIC #1). The second read-out integrated circuit ROIC #2 and the second source driver integrated circuit SDIC #2 may be integrated and implemented as a second source read-out integrated circuit (SRIC #2). The third read-out integrated circuit ROIC #3 and the third source driver integrated circuit SDIC #3 may be integrated and implemented as a third source read-out integrated circuit (SRIC #3).

As described above, integrated implementation of the touch driving circuit 210 for touch driving and the data driving circuit 120 for data driving may be more suitable when the touch sensor is an embedded touch sensor included in the display panel 110 and signal lines SL connected to the touch electrodes TE are arranged in parallel with the data lines DL.

According to the integrated implementation of the touch driving circuit 210 and the data driving circuit 120, touch driving and data driving may be effectively performed.

Meanwhile, when the touch panel TSP is of an embedded type included in the display panel 110, each touch electrode TE may be formed in various ways.

When the touch display device 100 is implemented as a type such as a liquid crystal display device, during display driving for image display, a common electrode to which a common voltage is applied may be divided into a plurality of electrodes, and the divided common electrodes may be used as the plurality of touch electrodes TE.

In this case, during a display driving period, one or more read-out integrated circuits (ROIC #1, ROIC #2, ROIC #3) included in the touch driving circuit 210 may supply a common voltage, which is a type of display driving voltage, to the plurality of touch electrodes TE.

During a touch driving period, one or more read-out integrated circuits (ROIC #1, ROIC #2, ROIC #3) included in the touch driving circuit 210 may supply a touch driving signal to at least one of the plurality of touch electrodes TE, sense at least one of the plurality of touch electrodes TE, generate touch sensing data, and output the touch sensing data to the touch controller 220.

Meanwhile, when the touch display device 100 is implemented as an organic light-emitting display device, the display panel 110 may include a common electrode (e.g., a cathode electrode) to which a common voltage is applied, and an encapsulation layer disposed on the common electrode.

For example, the common electrode may be divided into a plurality of electrodes, and the divided common electrodes may be used as the plurality of touch electrodes TE. The plurality of common electrodes may be the common electrodes CE of the light-emitting devices ED in each sub-pixel SP.

In another example, a plurality of touch electrodes TE may be separately formed on the encapsulation layer.

As described above, each touch electrode TE embedded in the display panel 110 of the touch display device 100 implemented as an organic light-emitting display device may be in the form of an electrode having no open area (opening). In this case, each of the plurality of touch electrodes TE may be a transparent electrode for emission of light from the sub-pixels SP. Alternatively, each touch electrode TE may be a mesh-type electrode having a plurality of open areas (openings). In this case, each open area in each touch electrode TE may correspond to an emission area of the sub-pixels SP (e.g., an area in which a part of the pixel electrode PE is located).

Meanwhile, when the touch driving circuit 210 supplies a touch driving signal to the touch electrode TE for touch sensing, other electrodes or signal lines not related to touch sensing may form unnecessary parasitic capacitance with the touch electrode TE. Such parasitic capacitance may reduce touch sensitivity.

Accordingly, the touch display device 100 according to embodiments of the present disclosure may perform load free driving (LFD) when the touch driving circuit 210 supplies the touch driving signal to the touch electrodes TE for touch sensing, and may supply, to other electrodes or signal lines not related to touch sensing, a load free driving signal identical or corresponding to the touch driving signal. The load free driving signal may be identical or similar to the touch driving signal in at least one of frequency, phase, and amplitude. In this case, the fact that at least one signal characteristic such as frequency, phase, and amplitude of the load free driving signal is similar to at least one signal characteristic such as frequency, phase, and amplitude of the touch driving signal may mean that, although not identical, a difference therebetween is within a predetermined allowable error range (e.g., 1%, 2%, 5%).

During load free driving, during a touch driving period, the load free driving signal may be applied to all or some of the plurality of data lines DL, or the load free driving signal may be applied to all or some of the plurality of gate lines GL.

During load free driving, during a touch driving period, the load free driving signal may be applied to touch electrodes TE located around the touch electrode TE being touch-sensed among the plurality of touch electrodes TE. Alternatively, during the touch driving period, the load free driving signal may be applied to all of the plurality of touch electrodes TE.

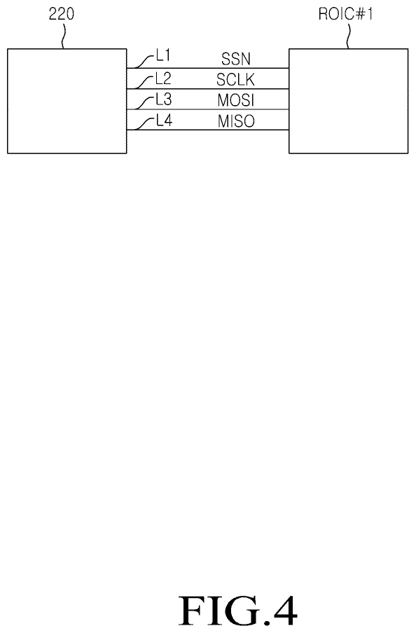

FIG. 4 is a diagram briefly illustrating a communication relationship between the touch controller 220 and a read-out integrated circuit according to example embodiments of the present disclosure.

For convenience of explanation, the first read-out integrated circuit ROIC #1 and the touch controller 220 are illustrated.

The touch controller 220 may exchange data with the first read-out integrated circuit ROIC #1 through SPI communication. SPI stands for Serial Peripheral Interface. SPI communication refers to communication through a synchronous serial data transfer method between a master and a slave. The touch controller 220 may correspond to a master, and the first read-out integrated circuit ROIC #1 may correspond to a slave.

As shown in FIG. 4, the touch controller 220 may be electrically connected to the first read-out integrated circuit ROIC #1 through a first signal line L1. The touch controller 220 may transmit a slave select signal SSN to the first read-out integrated circuit ROIC #1 through the first signal line L1. The slave select signal SSN may be a signal for activating a specific slave. For example, when the touch controller 220 supplies a signal in a first voltage state to the first read-out integrated circuit ROIC #1, the touch controller 220 may be able to exchange data with the first read-out integrated circuit ROIC #1. When the communication is completed, the touch controller 220 may supply a signal in a second voltage state to the first read-out integrated circuit ROIC #1.

As shown in FIG. 4, the touch controller 220 may be electrically connected to the first read-out integrated circuit ROIC #1 through a second signal line L2. The touch controller 220 may transmit a serial clock signal SCLK to the first read-out integrated circuit ROIC #1 through the second signal line L2. The serial clock signal SCLK may be a signal for synchronizing the touch controller 220 and the first read-out integrated circuit ROIC #1.

As shown in FIG. 4, the touch controller 220 may be electrically connected to the first read-out integrated circuit ROIC #1 through a third signal line L3. The touch controller 220 may transmit data to the first read-out integrated circuit ROIC #1 through the third signal line L3. The third signal line L3 may be MOSI (Master Out Slave In).

As shown in FIG. 4, the touch controller 220 may be electrically connected to the first read-out integrated circuit ROIC #1 through a fourth signal line L4. The touch controller 220 may receive data from the first read-out integrated circuit ROIC #1 through the fourth signal line L4. The fourth signal line L4 may be MISO (Master In Slave Out).

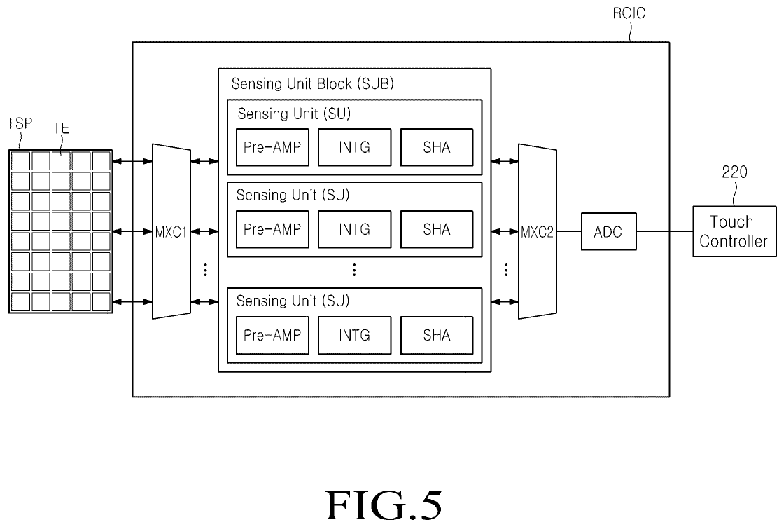

FIG. 5 illustrates a read-out integrated circuit ROIC constituting the touch driving circuit 210 of the touch sensing system according to example embodiments of the present disclosure.

As shown in FIG. 5, the read-out integrated circuit ROIC according to example embodiments of the present disclosure may include a first multiplexer circuit MXC1, a sensing unit block SUB including one or more sensing units SUs, a second multiplexer circuit MXC2, and an analog-to-digital converter ADC.

The first multiplexer circuit MXC1 may select one or more touch electrodes TE among the plurality of touch electrodes TE as sensing targets. The first multiplexer circuit MXC1 may include one or two or more multiplexers.

Each sensing unit SU included in the sensing unit block SUB may drive and sense one touch electrode TE selected as a sensing target at a given time.

The second multiplexer circuit MXC2 may select one of the plurality of sensing units SUs included in the sensing unit block SUB and connect the selected sensing unit SU to the analog-to-digital converter ADC. The second multiplexer circuit MXC2 may include one or two or more multiplexers.

For example, each sensing unit SU included in the sensing unit block SUB may include a pre-amplifier (Pre-AMP), an integrator INTG, and a sample and hold circuit SHA.

The number of touch electrodes TE that can be simultaneously sensed at a given time among all the touch electrodes TE may correspond to the number of sensing units SUs.

The analog-to-digital converter ADC may convert a sensing result for each sensing unit SU selected by the second multiplexer circuit MXC2 into a sensing value corresponding to a digital value.

The read-out integrated circuit ROIC may collect the sensing values, generate touch sensing data, and provide the generated touch sensing data to the touch controller 220.

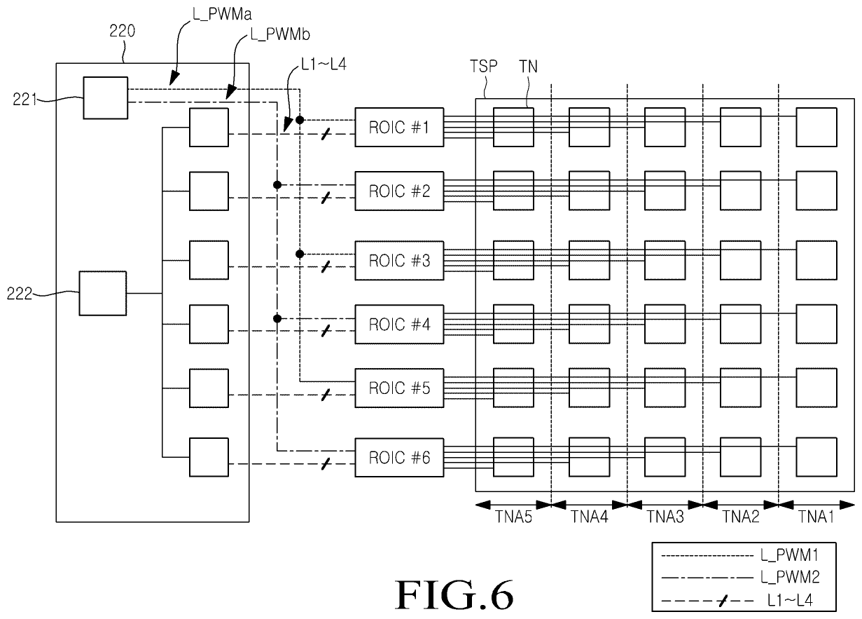

FIG. 6 is a diagram briefly illustrating a communication relationship between the touch controller 220 and a read-out integrated circuit ROIC according to example embodiments of the present disclosure.

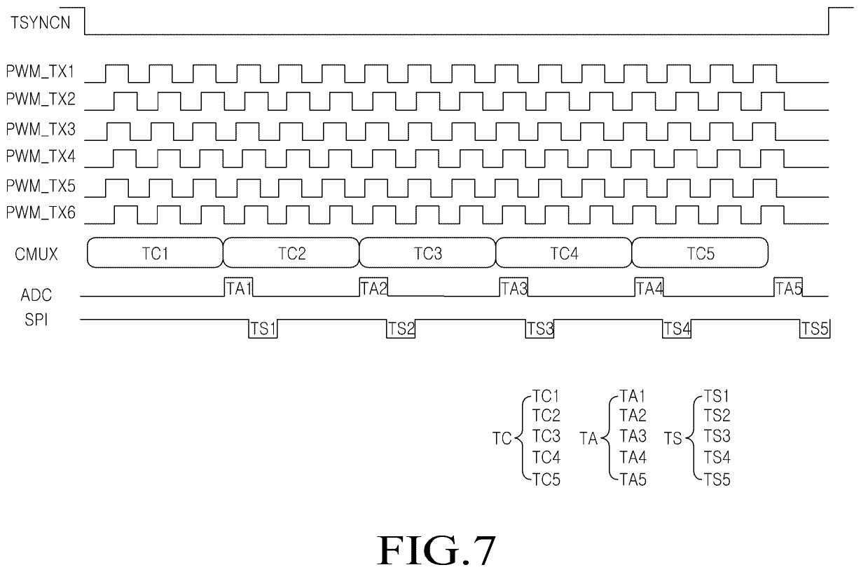

FIG. 7 is a diagram illustrating signals for driving the touch controller 220 and the read-out integrated circuit ROIC according to example embodiments of the present disclosure.

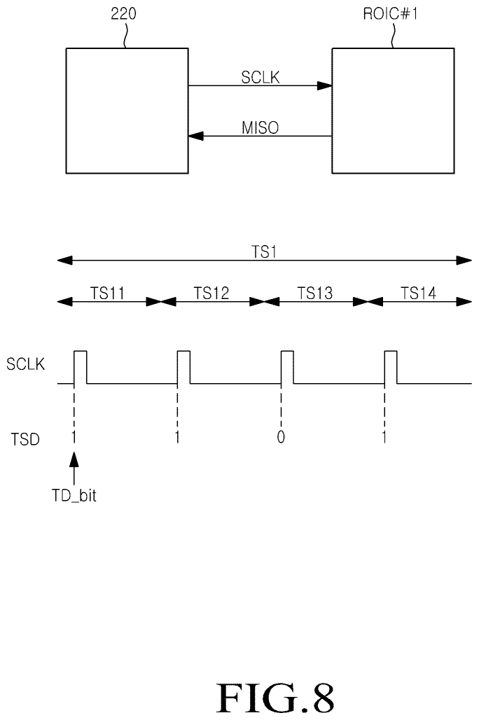

FIG. 8 is a diagram illustrating a method by which the read-out integrated circuit ROIC transmits data to the touch controller 220 according to example embodiments of the present disclosure.

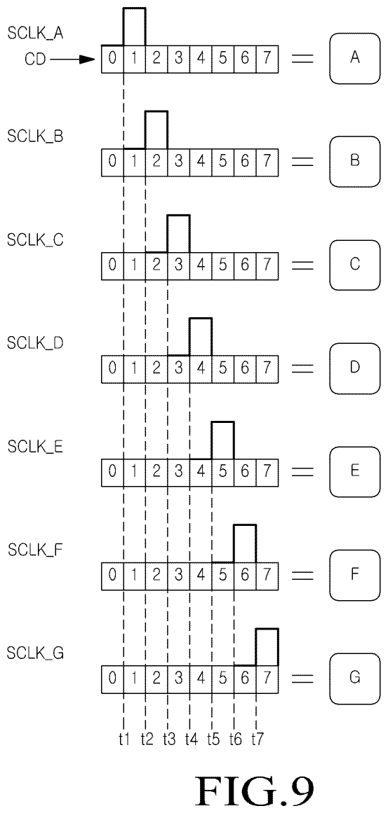

FIG. 9 is a diagram illustrating types of a serial clock signal SCLK according to example embodiments of the present disclosure.

As shown in FIG. 6, the touch controller 220 may be electrically connected to the plurality of read-out integrated circuits ROIC through a plurality of signal lines L1, L2, L3, and L4. The plurality of signal lines L1, L2, L3, and L4 are the first signal line L1, the second signal line L2, the third signal line L3, and the fourth signal line L4 illustrated in FIG. 4.

As shown in FIG. 6, the touch controller 220 may be electrically connected to the first read-out integrated circuit ROIC #1, the third read-out integrated circuit ROIC #3, and the fifth read-out integrated circuit ROIC #5 through a fifth signal line L_PWMa. The fifth signal line L_PWMa may be a signal line for supplying a first pulse-width signal PWM_TX1, PWM_TX3, and PWM_TX5.

As shown in FIG. 6, the touch controller 220 may be electrically connected to the second read-out integrated circuit ROIC #2, the fourth read-out integrated circuit ROIC #4, and the sixth read-out integrated circuit ROIC #6 through a sixth signal line L_PWMb. The sixth signal line L_PWMb may be a signal line for supplying a second pulse-width signal PWM_TX2, PWM_TX4, and PWM_TX6. However, the sixth signal line L_PWMb may not be disposed, and the touch controller 220 may be electrically connected to the second read-out integrated circuit ROIC #2, the fourth read-out integrated circuit ROIC #4, and the sixth read-out integrated circuit ROIC #6 through the fifth signal line L_PWMa.

As shown in FIG. 6, the plurality of read-out integrated circuits ROIC may be electrically connected to a plurality of touch nodes TN of the touch panel TSP. Each touch node TN may include at least one touch electrode TE. For example, the touch node TN may correspond to one touch electrode TE, or may include a plurality of touch electrodes TE. As shown in FIG. 6, for convenience of explanation, the plurality of touch nodes TN are illustrated as being thirty in number, but are not limited thereto.

As shown in FIG. 6, the touch controller 220 may include a pulse-width signal generator 221. The pulse-width signal generator 221 may generate the first pulse-width signals PWM_TX1, PWM_TX3, and PWM_TX5 and the second pulse-width signals PWM_TX2, PWM_TX4, and PWM_TX6. The touch controller 220 may output the first pulse-width signals PWM_TX1, PWM_TX3, and PWM_TX5 and the second pulse-width signals PWM_TX2, PWM_TX4, and PWM_TX6 to the plurality of read-out integrated circuits ROIC.

As shown in FIG. 7, the first pulse-width signals PWM_TX1, PWM_TX3, and PWM_TX5 may be signals that change between a high-level signal state and a low-level signal state at a predetermined cycle. The first pulse-width signals PWM_TX1, PWM_TX3, and PWM_TX5 may be PWM signals. The second pulse-width signals PWM_TX2, PWM_TX4, and PWM_TX6 may also be PWM signals, and may have a shape different from that of the first pulse-width signals PWM_TX1, PWM_TX3, and PWM_TX5. For example, a rising edge time point of the first pulse-width signals PWM_TX1, PWM_TX3, and PWM_TX5 may be different from a rising edge time point of the second pulse-width signals PWM_TX2, PWM_TX4, and PWM_TX6. A falling edge time point of the first pulse-width signals PWM_TX1, PWM_TX3, and PWM_TX5 may be different from a falling edge time point of the second pulse-width signals PWM_TX2, PWM_TX4, and PWM_TX6. Because the rising edge time points of the first pulse-width signals PWM_TX1, PWM_TX3, and PWM_TX5 are different from the rising edge time points of the second pulse-width signals PWM_TX2, PWM_TX4, and PWM_TX6, signal interference between the signals may be prevented or reduced.

As shown in FIG. 7, a touch synchronization signal TSYNCN may be in a high-level signal state or a low-level signal state. Touch sensing may be performed when the touch synchronization signal TSYNCN is in a low-level signal state. The touch synchronization signal TSYNCN illustrated in FIG. 7 may be generated by the touch controller 220 illustrated in FIG. 6, and the touch controller 220 illustrated in FIG. 6 may transmit the touch synchronization signal TSYNCN of FIG. 7 to the plurality of read-out integrated circuits ROIC illustrated in FIG. 6.

As shown in FIG. 7, when the touch synchronization signal TSYNCN is in the low-level signal state, the touch controller 220 may output the first pulse-width signals PWM_TX1, PWM_TX3, and PWM_TX5 and the second pulse-width signals PWM_TX2, PWM_TX4, and PWM_TX6. The touch controller 220 may continuously output the first pulse-width signals PWM_TX1, PWM_TX3, and PWM_TX5 and the second pulse-width signals PWM_TX2, PWM_TX4, and PWM_TX6 until the touch synchronization signal TSYNCN becomes the high-level signal state.

The plurality of read-out integrated circuits ROIC may generate a first touch driving signal based on the first pulse-width signals PWM_TX1, PWM_TX3, and PWM_TX5, and the first touch driving signal may be output to the touch node TN. The plurality of read-out integrated circuits ROIC may generate a second touch driving signal based on the second pulse-width signals PWM_TX2, PWM_TX4, and PWM_TX6, and the second touch driving signal may be output to the touch node TN. The first touch driving signal may have a waveform different from that of the second touch driving signal, and a rising edge time point and a falling edge time point thereof may be different from those of the second touch driving signal.

As shown in FIG. 6, the plurality of touch nodes TN may be located in each of a first touch node area TNA1, a second touch node area TNA2, a third touch node area TNA3, a fourth touch node area TNA4, and a fifth touch node area TNA5. As shown in FIG. 7, a multiplexer control signal CMUX may be driven to be divided into a first mux control period TC1, a second mux control period TC2, a third mux control period TC3, a fourth mux control period TC4, and a fifth mux control period TC5. The nth mux control period may be a period for sensing whether a touch occurs in the nth touch node area TNA where n is a natural number. That is, the area in which the touch node TN is located may be divided, and touch time-division driving may be performed. However, when the number of read-out integrated circuits ROIC is the same as the number of touch nodes TN, touch sensing may be performed simultaneously for all touch nodes TN.

As shown in FIG. 7, during the nth mux control period TC, a touch driving signal may be supplied to the touch nodes TN of the nth touch node area TNA. The touch driving signal is a signal generated by the read-out integrated circuit ROIC based on the first pulse-width signals PWM_TX1, PWM_TX3, and PWM_TX5 and the second pulse-width signals PWM_TX2, PWM_TX4, and PWM_TX6.

As shown in FIG. 7, after the touch driving signal is supplied to the touch nodes TN of the first touch node area TNA1 during the first mux control period TC1, a first conversion period TA1 may be performed. The first conversion period TA1 may be a step in which the analog-to-digital converter of the read-out integrated circuit ROIC converts a touch sensing signal in an analog voltage state into touch sensing data TSD in a digital state. The first conversion period TA1 may overlap with the second mux control period TC2 after the first mux control period TC1, but is not limited thereto. As shown in FIG. 7, characteristics of the second to fifth conversion periods TA2, TA3, TA4, and TA5 are the same as characteristics of the first conversion period TA1. The number of conversion periods TA may be the same as the number of mux control periods TC.

As shown in FIG. 7, after the first conversion period TA1 is performed, a first communication period TS1 may be performed. The first communication period TS1 may be a period in which the touch sensing data TSD generated during the first conversion period TA1 is transmitted from the read-out integrated circuit ROIC to the touch controller 220. Characteristics of the second to fifth communication periods TS2, TS3, TS4, and TS5 are the same as characteristics of the first communication period TS1. The first to fifth communication periods TS1, TS2, TS3, TS4, and TS5 may be periods in which the read-out integrated circuit ROIC transmits the touch sensing data TSD to the touch controller 220 through SPI communication.

As shown in FIG. 8, the first communication period TS1 may include a first bit transmission period TS11, a second bit transmission period TS12, a third bit transmission period TS13, and a fourth bit transmission period TS14.

As shown in FIG. 8, in each of the first bit transmission period TS11, the second bit transmission period TS12, the third bit transmission period TS13, and the fourth bit transmission period TS14, the serial clock signal SCLK may change from a low-level signal state to a high-level signal state. When the serial clock signal SCLK changes from the low-level signal state to the high-level signal state, the first read-out integrated circuit ROIC #1 may transmit a bit included in the touch sensing data TSD to the touch controller 220. That is, the first read-out integrated circuit ROIC #1 may transmit the touch sensing data TSD to the touch controller 220 in synchronization with the serial clock signal SCLK.

For convenience of explanation, only the first read-out integrated circuit ROIC #1 is illustrated in FIG. 8, and characteristics of the first read-out integrated circuit ROIC #1 also apply to the other read-out integrated circuits ROIC.

As shown in FIG. 8, for example, the touch sensing data TSD may be 4 bits and may be “1101.” The first read-out integrated circuit ROIC #1 may transmit 1 bit of touch bit data TD_bit to the touch controller 220 during the first bit transmission period TS11. The first read-out integrated circuit ROIC #1 may transmit 1 bit during the second bit transmission period TS12, 0 bit during the third bit transmission period TS13, and 1 bit during the fourth bit transmission period TS14 to the touch controller 220.

Although the touch sensing data TSD has been described by way of example as being 4 bits, the touch sensing data TSD may be set to 8 bits, 12 bits, 16 bits, or the like depending on the purpose.

As shown in FIG. 8, for convenience of explanation, only the first read-out integrated circuit ROIC #1 is illustrated, but the other read-out integrated circuits ROIC illustrated in FIG. 6 also transmit bits to the touch controller 220 during the first to fourth bit transmission periods TS11, TS12, TS13, and TS14.

As shown in FIG. 6, the touch controller 220 may include a count circuit unit 222. The count circuit unit 222 may generate count data CD based on a predetermined period. For example, the count circuit unit 222 may generate count data CD of 0 to 7 based on eight sections. The touch controller 220 may generate a serial clock signal SCLK based on the count data CD generated by the count circuit unit 222. The touch controller 220 may output the serial clock signal SCLK to the plurality of read-out integrated circuits ROIC.

As shown in FIG. 9, a time point at which the serial clock signal SCLK changes from a low-level signal state to a high-level signal state may be determined based on the count data CD.

As shown in FIG. 9, when the count data CD is 1, a first type A serial clock signal SCLK_A may be generated. As shown in FIG. 9, when the count data CD is k, a kth type serial clock signal SCLK may be generated. k is 1, 2, 3, 4, 5, 6, and 7. As shown in FIG. 9, the respective serial clock signals SCLK_A, SCLK_B, SCLK_C, SCLK_D, SCLK_E, SCLK_F, and SCLK_G may have different rising edge timings from one another.

As shown in FIG. 9, at a kth time point, only the kth type serial clock signal may change from the low-level signal state to the high-level signal state.

The first type serial clock signal SCLK_A may change from the low-level signal state to the high-level signal state at a first time point t1. The first time point t1 may be a time point at which the count data CD changes from 0 to 1. That is, the first time point t1 may be a rising edge time point of the first type serial clock signal SCLK_A. The first type serial clock signal SCLK_A may be defined as a first waveform.

The second type serial clock signal SCLK_B may change from the low-level signal state to the high-level signal state at a second time point t2. The second time point t2 may be a time point at which the count data CD changes from 1 to 2. That is, the second time point t2 may be a rising edge time point of the second type serial clock signal SCLK_B. The second type serial clock signal SCLK_B may be defined as a second waveform.

The third type serial clock signal SCLK_C may change from the low-level signal state to the high-level signal state at a third time point t3. The third time point t3 may be a time point at which the count data CD changes from 2 to 3. That is, a fourth time point t4 may be a rising edge time point of the third type serial clock signal SCLK_C. The third type serial clock signal SCLK_C may be defined as a third waveform.

The fourth type serial clock signal SCLK_D may change from the low-level signal state to the high-level signal state at a fourth time point t4. The fourth time point t4 may be a time point at which the count data CD changes from 3 to 4. That is, the fourth time point t4 may be a rising edge time point of the fourth type serial clock signal SCLK_D. The fourth type serial clock signal SCLK_D may be defined as a fourth waveform.

The fifth type serial clock signal SCLK_E may change from the low-level signal state to the high-level signal state at a fifth time point t5. The fifth time point t5 may be a time point at which the count data CD changes from 4 to 5. That is, the fifth time point t5 may be a rising edge time point of the fifth type serial clock signal SCLK_E. The fifth type serial clock signal SCLK_E may be defined as a fifth waveform.

The sixth type serial clock signal SCLK_F may change from the low-level signal state to the high-level signal state at a sixth time point t6. The sixth time point t6 may be a time point at which the count data CD changes from 5 to 6. That is, the sixth time point t6 may be a rising edge time point of the sixth type serial clock signal SCLK_F. The sixth type serial clock signal SCLK_F may be defined as a sixth waveform.

The seventh type serial clock signal SCLK_G may change from the low-level signal state to the high-level signal state at a seventh time point t7. The seventh time point t7 may be a time point at which the count data CD changes from 6 to 7. That is, the seventh time point t7 may be a rising edge time point of the seventh type serial clock signal SCLK_G. The seventh type serial clock signal SCLK_G may be defined as a seventh waveform.

As shown in FIG. 9, at the first time point t1, only the first type serial clock signal SCLK_A may change from the low-level signal state to the high-level signal state, and it can be confirmed that the other serial clock signals SCLK_B to SCLK_G are in the low-level signal state. That is, the first time point t1 may be a rising edge time point of the first type serial clock signal SCLK_A.

As shown in FIG. 9, at the second time point t2, only the second type serial clock signal SCLK_B may change from the low-level signal state to the high-level signal state, and it can be confirmed that the other serial clock signals SCLK_A, SCLK_C to SCLK_G are in the low-level signal state. That is, the second time point t2 may be a rising edge time point of the second type serial clock signal SCLK_B.

That is, at the kth time point, only the kth type serial clock signal may change from the low-level signal state to the high-level signal state, and the other serial clock signals may remain in the low-level signal state.

Each of the serial clock signals SCLK_A, SCLK_B, SCLK_C, SCLK_D, SCLK_E, SCLK_F, and SCLK_G may change to the high-level signal state in accordance with a specific count data CD, and then change to the low-level signal state in accordance with a next count data CD.

As shown in FIG. 9, the serial clock signals SCLK_A, SCLK_B, SCLK_C, SCLK_D, SCLK_E, SCLK_F, and SCLK_G are illustrated as being in the high-level signal state during a period in which one count data CD is maintained. That is, the serial clock signals SCLK_A, SCLK_B, SCLK_C, SCLK_D, SCLK_E, SCLK_F, and SCLK_G are illustrated as pulse-width signals that are in the high-level signal state for a predetermined period.

The pulse widths of the serial clock signals SCLK_A, SCLK_B, SCLK_C, SCLK_D, SCLK_E, SCLK_F, and SCLK_G illustrated in FIG. 9 are merely one example, and the pulse widths may be lengthened or shortened. In this case, the periods in which the serial clock signals SCLK_A, SCLK_B, SCLK_C, SCLK_D, SCLK_E, SCLK_F, and SCLK_G are in the high-level signal state may overlap with one another. However, even in this case, time points at which the respective serial clock signals SCLK_A, SCLK_B, SCLK_C, SCLK_D, SCLK_E, SCLK_F, and SCLK_G change from the low-level signal state to the high-level signal state may be different from one another. That is, a pulse width length or a duty ratio in which the respective serial clock signals SCLK_A, SCLK_B, SCLK_C, SCLK_D, SCLK_E, SCLK_F, and SCLK_G are in the high-level signal state may be set differently from those in FIG. 9.

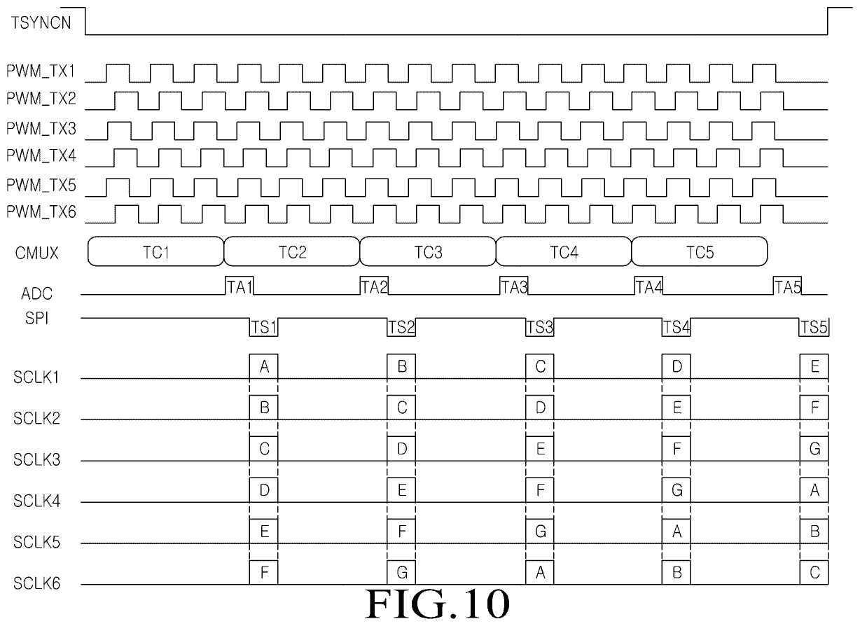

As shown in FIG. 9, for convenience of explanation, the serial clock signals SCLK of the first to seventh types (A, B, C, D, E, F, G) may be represented as A to G. As shown in FIG. 10, it can be confirmed that the serial clock signals SCLK_A, SCLK_B, SCLK_C, SCLK_D, SCLK_E, SCLK_F, and SCLK_G are represented as A to G.

FIG. 10 is a driving timing diagram including a serial clock signal SCLK according to example embodiments of the present disclosure.

FIG. 10 is a diagram in which first to sixth serial clock signals SCLK1, SCLK2, SCLK3, SCLK4, SCLK5, and SCLK6 are added to the driving timing diagram illustrated in FIG. 7.

As shown in FIG. 10, in each of the plurality of communication periods TS1 to TS5, the types of the plurality of serial clock signals SCLK may be different from one another.

For example, in the first communication period TS1, the first to sixth serial clock signals SCLK1, SCLK2, SCLK3, SCLK4, SCLK5, and SCLK6 may be A, B, C, D, E, and F.

For example, in the second communication period TS2, the first to sixth serial clock signals SCLK1, SCLK2, SCLK3, SCLK4, SCLK5, and SCLK6 may be B, C, D, E, F, and G.

For example, in the third communication period TS3, the first to sixth serial clock signals SCLK1, SCLK2, SCLK3, SCLK4, SCLK5, and SCLK6 may be C, D, E, F, G, and A.

For example, in the fourth communication period TS4, the first to sixth serial clock signals SCLK1, SCLK2, SCLK3, SCLK4, SCLK5, and SCLK6 may be D, E, F, G, A, and B.

For example, in the fifth communication period TS5, the first to sixth serial clock signals SCLK1, SCLK2, SCLK3, SCLK4, SCLK5, and SCLK6 may be E, F, G, A, B, and C.

When the types of the plurality of serial clock signals SCLK are different from one another in the same communication period, signal interference between the serial clock signals SCLK may not occur. Accordingly, the serial clock signal SCLK may be stably transmitted from the touch controller 220 to the read-out integrated circuit ROIC. In addition, the read-out integrated circuit ROIC may stably transmit the touch sensing data TSD to the touch controller 220.

As shown in FIG. 4, FIG. 6, FIG. 9, and FIG. 10, characteristics of the first communication period TS1 are as follows. In the first communication period TS1, the first serial clock signal SCLK1 may be output from the touch controller 220 to the first read-out integrated circuit ROIC #1 through the second signal line L2 illustrated in FIG. 6. The first serial clock signal SCLK1 of FIG. 10 corresponds to the first type serial clock signal SCLK_A of FIG. 9 and may change from the low-level signal state to the high-level signal state earlier than the other serial clock signals SCLK2 to SCLK6.

In the first communication period TS1, the second serial clock signal SCLK2 may be output from the touch controller 220 to the second read-out integrated circuit ROIC #2 through the second signal line L2 illustrated in FIG. 6. The second serial clock signal SCLK2 of FIG. 10 corresponds to the second type serial clock signal SCLK_B of FIG. 9, and the second serial clock signal SCLK2 of FIG. 10 may change to the high-level signal state later than the first serial clock signal SCLK1 of FIG. 10. That is, a rising edge time point of the second serial clock signal SCLK2 of FIG. 10 may be later than a rising edge time point of the first serial clock signal SCLK1 of FIG. 10.

In the first communication period TS1, each of the remaining serial clock signals SCLK3 to SCLK6 may also be output from the touch controller 220 through the second signal line L2 illustrated in FIG. 6. The types of the remaining serial clock signals SCLK3 to SCLK6 may correspond to the third type SCLK_C, the fourth type SCLK_D, the fifth type SCLK_E, and the sixth type SCLK_F illustrated in FIG. 9, and the rising edge time points of the remaining serial clock signals SCLK3 to SCLK6 may be different from one another. Accordingly, signal interference between the serial clock signals SCLK may be prevented or reduced.

The first communication period TS1 has been described as an example, and the characteristics of the first communication period TS1 may be the same for the other communication periods TS. Repetitive descriptions of the other communication periods TS will be omitted.

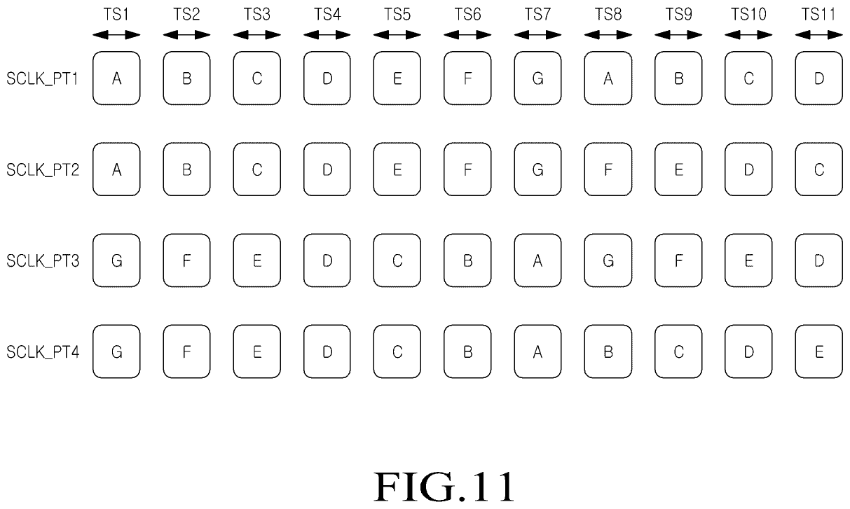

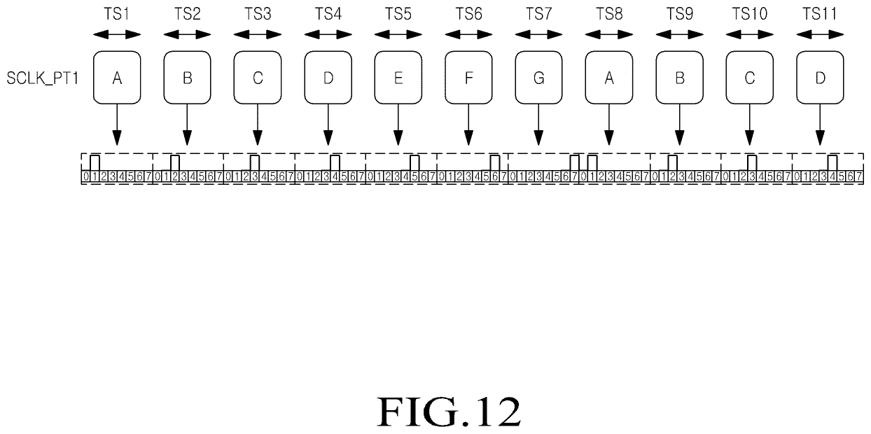

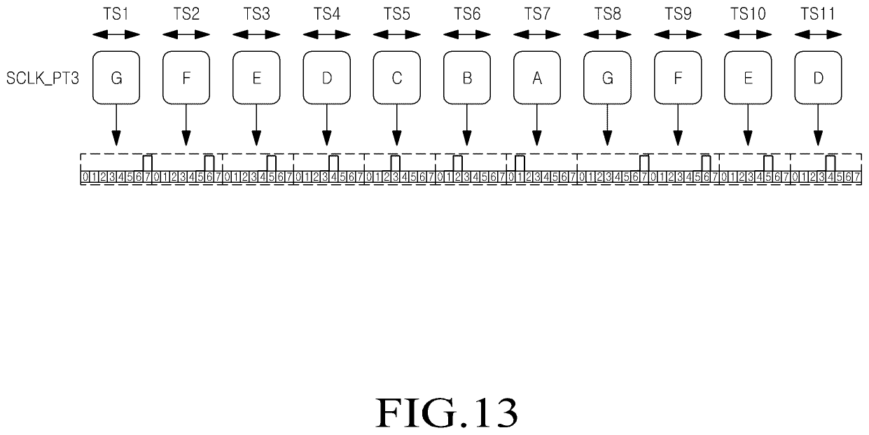

FIG. 11, FIG. 12, and FIG. 13 illustrate patterns SCLK_PT1, SCLK_PT2, SCLK_PT3, and SCLK_PT4 of the serial clock signal according to example embodiments of the present disclosure.

As shown in FIG. 11, an example diagram for the patterns SCLK_PT1, SCLK_PT2, SCLK_PT3, and SCLK_PT4 of the serial clock signal can be confirmed.

The type of the serial clock signal SCLK may be changed in each of the first to eleventh communication periods TS1 to TS11.

As shown in FIG. 11 and FIG. 12, a first pattern SCLK_PT1 of the serial clock signal may be a pattern in which the types change to A, B, C, D, E, F, G, A, B, C, and D in each of the first to eleventh communication periods TS1 to TS11.

As shown in FIG. 11, a second pattern SCLK_PT2 of the serial clock signal may be a pattern in which the types change to A, B, C, D, E, F, G, F, E, D, and C in each of the first to eleventh communication periods TS1 to TS11.

As shown in FIG. 11 and FIG. 13, a third pattern SCLK_PT3 of the serial clock signal may be a pattern in which the types change to G, F, E, D, C, B, A, G, F, E, and D in each of the first to eleventh communication periods TS1 to TS11.

As shown in FIG. 11, a fourth pattern SCLK_PT4 of the serial clock signal may be a pattern in which the types change to G, F, E, D, C, B, A, B, C, D, and E in each of the first to eleventh communication periods TS1 to TS11.

Although not illustrated in FIG. 11, the same type may be output consecutively at least twice, such as A, A, B, B, C, C. In addition, the pattern may be output in an arbitrary order, such as A, B, B, C, C, C, or A, E, B, D, F, C, etc.

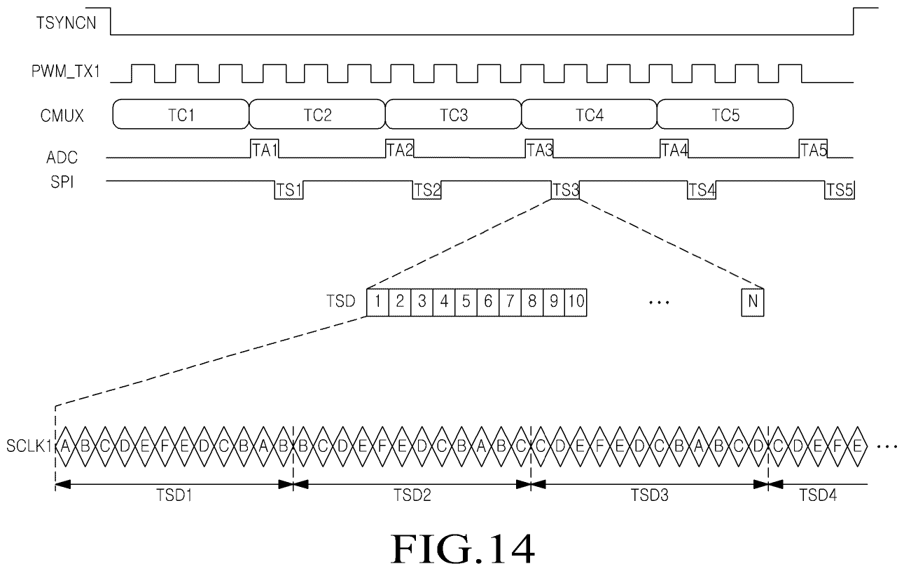

FIG. 14 is a driving timing diagram including a serial clock signal SCLK according to embodiments of the present disclosure.

As shown in FIG. 14, the touch synchronization signal TSYNCN, the first pulse-width signals PWM_TX1, PWM_TX3, and PWM_TX5, the multiplexer control signal CMUX, and the plurality of communication periods TS1 to TS5 illustrated in FIG. 14 are the same as those illustrated in FIG. 7.

As shown in FIG. 14, in one communication period TS, a plurality of touch sensing data TSD may be transmitted from the read-out integrated circuit ROIC to the touch controller 220.

For example, in the third communication period TS3, first to N-th touch sensing data TSD may be transmitted from the read-out integrated circuit ROIC to the touch controller 220.

As shown in FIG. 5, the first multiplexer circuit MXC1 and the second multiplexer circuit MXC2 are illustrated, and the plurality of touch sensing data TSD may be output from the read-out integrated circuit ROIC to the touch controller 220 within one communication period TS according to control of the first multiplexer circuit MXC1 or the second multiplexer circuit MXC2.

For example, as the first multiplexer circuit MXC1 illustrated in FIG. 5 sequentially selects a plurality of touch electrodes TE, the plurality of touch sensing data TSD may be generated and output to the touch controller 220. In addition, as the second multiplexer circuit MXC2 illustrated in FIG. 5 sequentially selects a plurality of sensing units SU, the plurality of touch sensing data TSD may be generated and output to the touch controller 220.

As shown in FIG. 14, each of the plurality of touch sensing data TSD may consist of 12 bits.

As shown in FIG. 14, first to fourth touch sensing data TSD1 to TSD4 can be confirmed.

As shown in FIG. 14, the first touch sensing data TSD1 may be synchronized with the first serial clock signal SCLK1 and may transmit 12 bits to the touch controller 220. In this case, the type of the first serial clock signal SCLK1 may be A, B, C, D, E, F, E, D, C, B, A, and B.

As shown in FIG. 14, the second touch sensing data TSD2 may be synchronized with the first serial clock signal SCLK1 and may transmit 12 bits to the touch controller 220. In this case, the type of the first serial clock signal SCLK1 may be B, C, D, E, F, E, D, C, B, A, B, and C. The first bit of the first touch sensing data TSD1 may be synchronized with the first serial clock signal SCLK1 of type A, and the first bit of the second touch sensing data TSD2 may be synchronized with the first serial clock signal SCLK1 of type B.

As shown in FIG. 14, the third touch sensing data TSD3 may be synchronized with the first serial clock signal SCLK1 and may transmit 12 bits to the touch controller 220. In this case, the type of the first serial clock signal SCLK1 may be C, D, E, F, E, D, C, B, A, B, C, and D.

As shown in FIG. 14, the fourth touch sensing data TSD4 may be synchronized with the first serial clock signal SCLK1 and may transmit 12 bits to the touch controller 220. In this case, the type of the first serial clock signal SCLK1 may change in the order of D, E, F, and E.

As shown in FIG. 14, the first serial clock signal SCLK1 is illustrated as being the second pattern SCLK_PT2 illustrated in FIG. 11, but the first serial clock signal SCLK1 illustrated in FIG. 14 may be designed to correspond to the other patterns SCLK_PT1, SCLK_PT3, and SCLK_PT4.

By changing the type of the serial clock signal SCLK, signal interference that may occur between the serial clock signals SCLK can be prevented or reduced.

As the signal interference is prevented, reduced, or minimized, the touch sensing data can be stably transmitted to the touch controller.

In addition, as the signal interference is prevented, reduced, or minimized, touch sensing can be performed more stably.

A display device according to various example embodiments of the present disclosure can be described as follows.

The touch controller may exchange signals with the read-out integrated circuit through SPI communication. The touch controller may supply a touch synchronization signal to the read-out integrated circuit, and the read-out integrated circuit may start a touch operation according to a signal level of the touch synchronization signal. The read-out integrated circuit may receive a pulse-width signal from the touch controller and generate a touch driving signal based thereon. The read-out integrated circuit may supply the touch driving signal to a plurality of touch electrodes.

Thereafter, the read-out integrated circuit may sense a touch electrode, and may sense a touch sensing signal in an analog state through a sensing operation. The read-out integrated circuit may convert the touch sensing signal into touch sensing data through an ADC. The read-out integrated circuit may transmit the touch sensing data to the touch controller. In this case, the read-out integrated circuit may perform SPI communication with the touch controller. The touch controller may transmit a serial clock signal to the read-out integrated circuit, and the read-out integrated circuit may transmit the touch sensing data in synchronization with the serial clock signal. The touch sensing data may be composed of a plurality of bits and, for example, may be 12 bits or 16 bits. The read-out integrated circuit may transmit one bit included in the touch sensing data to the touch controller at a point in time when the serial clock signal has a rising edge.

One touch controller may be electrically connected to a plurality of read-out integrated circuits. In this case, the touch controller may transmit serial clock signals having different waveforms to the respective plurality of read-out integrated circuits. Accordingly, signal interference between the serial clock signals may be prevented or reduced, and the touch sensing data may be stably transmitted to the touch controller.

According to one or more example embodiments of the present disclosure, a display device may include: a display panel in which a plurality of sub-pixels and a plurality of touch electrodes are disposed; a first read-out integrated circuit electrically connected to a first touch electrode; a second read-out integrated circuit electrically connected to a second touch electrode; a touch controller electrically connected to the first read-out integrated circuit and the second read-out integrated circuit, and configured to receive touch sensing data from the first read-out integrated circuit and the second read-out integrated circuit; a first serial clock signal transmitted from the touch controller to the first read-out integrated circuit and having a signal level change at a first time point; and a second serial clock signal transmitted from the touch controller to the second read-out integrated circuit and having a signal level change at a second timing different from the first time point.

The first serial clock signal may change from a low-level signal state to a high-level signal state at the first time point, and the second serial clock signal may change from the low-level signal state to the high-level signal state at the second timing.

The first read-out integrated circuit may transmit first touch sensing data to the touch controller in synchronization with the first serial clock signal, and the second read-out integrated circuit may transmit second touch sensing data to the touch controller in synchronization with the second serial clock signal.

The first read-out integrated circuit may transmit the first touch sensing data to the touch controller at the first time point, and the second read-out integrated circuit may transmit the second touch sensing data to the touch controller at the second timing.

The touch controller may further include a count circuit that generates a plurality of count data, and the touch controller may generate the first serial clock signal and the second serial clock signal based on the plurality of count data.

The first time point may be a timing at which first count data is changed to second count data, and the second timing may be a timing at which the second count data is changed to third count data.

The touch controller may transmit a plurality of serial clock signals to a plurality of read-out integrated circuits, and the plurality of serial clock signals may be: a first waveform having a signal level change when first count data is changed to second count data; a second waveform having a signal level change when the second count data is changed to third count data; or a third waveform having a signal level change when the third count data is changed to fourth count data.

The first serial clock signal may be the first waveform in a first period, the second waveform in a second period, the third waveform in a third period, and the first waveform in a fourth period.

The first serial clock signal may be the first waveform in a first period, the second waveform in a second period, the third waveform in a third period, and the second waveform in a fourth period.

The first serial clock signal may be the third waveform in the first period, the second waveform in the second period, the first waveform in the third period, and the third waveform in the fourth period.

The first serial clock signal may be the third waveform in the first period, the second waveform in the second period, the first waveform in the third period, and the second waveform in the fourth period.

The second serial clock signal may be the second waveform in the first period, the third waveform in the second period, the first waveform in the third period, and the second waveform in the fourth period.

The first read-out integrated circuit may transmit a plurality of touch sensing data to the touch controller in each of the first and second periods. When the first read-out integrated circuit transmits first touch sensing data to the touch controller in the first period, the touch controller may transmit the first serial clock signal, which changes to the first waveform, the second waveform, and the third waveform, to the first read-out integrated circuit. When the first read-out integrated circuit transmits second touch sensing data to the touch controller in the first period, the touch controller may transmit the first serial clock signal, which changes to the second waveform, the third waveform and the first waveform, to the first read-out integrated circuit.

The first read-out integrated circuit may receive a first pulse-width signal from the touch controller, the second read-out integrated circuit may receive a second pulse-width signal different from the first pulse-width signal from the touch controller, and the first pulse-width signal and the second pulse-width signal may be signals in which a voltage level varies at a predetermined cycle.

The first read-out integrated circuit may supply a first touch driving signal, generated based on the first pulse-width signal, to the first touch electrode, and the second read-out integrated circuit may supply a second touch driving signal, generated based on the second pulse-width signal, to the second touch electrode.

The first read-out integrated circuit may supply the first touch driving signal to the first touch electrode in the first period, and may supply the first touch driving signal to a third touch electrode in the second period, and the second read-out integrated circuit may supply the second touch driving signal to the first touch electrode in the first period, and may supply the second touch driving signal to a fourth touch electrode in the second period.

The display device may further include: a first signal line electrically connecting the touch controller and the first read-out integrated circuit, and transmitting a signal for selecting the first read-out integrated circuit; a second signal line electrically connecting the touch controller and the first read-out integrated circuit, and supplying the first serial clock signal; a third signal line electrically connecting the touch controller and the first read-out integrated circuit, and configured by the touch controller to transmit a signal to the first read-out integrated circuit; and a fourth signal line electrically connecting the touch controller and the first read-out integrated circuit, and configured by the first read-out integrated circuit to transmit a signal to the touch controller.

The first read-out integrated circuit may transmit first touch sensing data including a plurality of bits to the touch controller via the fourth signal line, and may transmit a first bit included in the plurality of bits to the touch controller at the first time point, and may transmit a second bit included in the plurality of bits to the touch controller at the second timing.

Each of the first read-out integrated circuit and the second read-out integrated circuit may include an analog-to-digital converter for generating the touch sensing data based on an analog voltage.

The display device may further include a first source read-out integrated circuit including the first read-out integrated circuit and a first source driver integrated circuit, and a second source read-out integrated circuit including the second read-out integrated circuit and a second source driver integrated circuit.

The above description has been presented to enable any person skilled in the art to make and use the technical idea of the present disclosure, and has been provided in the context of particular example applications and their example designs or specifications. Various modifications, additions and substitutions to the described example embodiments will be readily apparent to those skilled in the art, and the general principles defined herein may be applied to other embodiments and applications without departing from the spirit and scope of the present disclosure. The above description and the accompanying drawings provide examples of the technical idea of the present disclosure for illustrative purposes only. That is, the disclosed embodiments are intended to illustrate, not limit, the scope of the technical idea of the present disclosure by way of example.

What is claimed is:

1. A display device, comprising:
a display panel on which a plurality of sub-pixels and a plurality of touch electrodes are disposed;
a first read-out integrated circuit electrically connected to a first touch electrode;
a second read-out integrated circuit electrically connected to a second touch electrode;
a touch controller electrically connected to the first read-out integrated circuit and the second read-out integrated circuit and receiving touch sensing data from the first read-out integrated circuit and the second read-out integrated circuit;
a first serial clock signal transmitted from the touch controller to the first read-out integrated circuit and having a signal level change at a first time point; and
a second serial clock signal transmitted from the touch controller to the second read-out integrated circuit and having a signal level change at a second time point different from the first time point.

2. The display device according to claim 1,
wherein the first serial clock signal transitions from a low-level signal state to a high-level signal state at the first time point, and
wherein the second serial clock signal transitions from the low-level signal state to the high-level signal state at the second time point.

3. The display device according to claim 1,
wherein the first read-out integrated circuit transmits first touch sensing data to the touch controller in synchronization with the first serial clock signal, and
wherein the second read-out integrated circuit transmits second touch sensing data to the touch controller in synchronization with the second serial clock signal.

4. The display device according to claim 1,
wherein the first read-out integrated circuit transmits first touch sensing data to the touch controller at the first time point, and
wherein the second read-out integrated circuit transmits second touch sensing data to the touch controller at the second time point.

5. The display device according to claim 1, wherein the touch controller outputs the first serial clock signal and the second serial clock signal based on a plurality of count data.

6. The display device according to claim 5,
wherein the first time point is a point at which first count data is changed to second count data, and
wherein the second time point is a point at which the second count data is changed to third count data.

7. The display device according to claim 5,
wherein the touch controller transmits a plurality of serial clock signals to a plurality of read-out integrated circuits, and
wherein the plurality of serial clock signals are:
a first waveform whose signal level changes when the first count data is changed to the second count data;
a second waveform whose signal level changes when the second count data is changed to the third count data; or
a third waveform whose signal level changes when the third count data is changed to fourth count data.

8. The display device according to claim 7, wherein the first serial clock signal has the first waveform in a first period, the second waveform in a second period, the third waveform in a third period, and the first waveform in a fourth period.

9. The display device according to claim 7, wherein the first serial clock signal has the first waveform in a first period, the second waveform in a second period, the third waveform in a third period, and the second waveform in a fourth period.

10. The display device according to claim 7, wherein the first serial clock signal has the third waveform in a first period, the second waveform in a second period, the first waveform in a third period, and the third waveform in a fourth period.

11. The display device according to claim 7, wherein the first serial clock signal has the third waveform in a first period, the second waveform in a second period, the first waveform in a third period, and the second waveform in a fourth period.

12. The display device according to claim 8, wherein the second serial clock signal has the second waveform in the first period, the third waveform in the second period, the first waveform in the third period, and the second waveform in the fourth period.

13. The display device according to claim 7,
wherein the first read-out integrated circuit transmits a plurality of touch sensing data to the touch controller in each of the first period and the second period, and
wherein, when the first read-out integrated circuit transmits first touch sensing data to the touch controller in the first period, the touch controller transmits the first serial clock signal that changes in the order of the first waveform, the second waveform and the third waveform, to the first read-out integrated circuit, and
wherein, when the first read-out integrated circuit transmits second touch sensing data to the touch controller in the first period, the touch controller transmits the first serial clock signal that changes in the order of the second waveform, the third waveform, and the first waveform, to the first read-out integrated circuit.

14. The display device according to claim 1,
wherein the first read-out integrated circuit receives a first pulse-width signal from the touch controller,
wherein the second read-out integrated circuit receives a second pulse-width signal, different from the first pulse-width signal, from the touch controller, and
wherein the first pulse-width signal and the second pulse-width signal are signals in which a voltage level varies with a predetermined cycle.

15. The display device according to claim 14,
wherein the first read-out integrated circuit supplies a first touch driving signal to the first touch electrode based on the first pulse-width signal, and
wherein the second read-out integrated circuit supplies a second touch driving signal to the second touch electrode based on the second pulse-width signal.

16. The display device according to claim 15,
wherein the first read-out integrated circuit supplies the first touch driving signal to the first touch electrode in a first period and to a third touch electrode in a second period, and
wherein the second read-out integrated circuit supplies the second touch driving signal to the first touch electrode in the first period and to a fourth touch electrode in the second period.

17. The display device according to claim 1, further comprising:
a first signal line that electrically connects the touch controller and the first read-out integrated circuit and transmits a signal for selecting the first read-out integrated circuit;
a second signal line that electrically connects the touch controller and the first read-out integrated circuit and supplies the first serial clock signal;
a third signal line that electrically connects the touch controller and the first read-out integrated circuit and is configured for the touch controller to transmit a signal to the first read-out integrated circuit; and
a fourth signal line that electrically connects the touch controller and the first read-out integrated circuit and is configured for the first read-out integrated circuit to transmit a signal to the touch controller.

18. The display device according to claim 17,
wherein the first read-out integrated circuit transmits first touch sensing data including a plurality of bits to the touch controller through the fourth signal line,
wherein the first read-out integrated circuit transmits a first bit included in the plurality of bits to the touch controller at the first time point, and
wherein the first read-out integrated circuit transmits a second bit included in the plurality of bits to the touch controller at the second time point.

19. The display device according to claim 1, further comprising:
a first source read-out integrated circuit including the first read-out integrated circuit and a first source driver integrated circuit; and
a second source read-out integrated circuit including the second read-out integrated circuit and a second source driver integrated circuit.

20. A display device, comprising:
a plurality of touch electrodes;
a first read-out integrated circuit electrically connected to a first touch electrode of the the plurality of touch electrodes;
a second read-out integrated circuit electrically connected to a second touch electrode of the the plurality of touch electrodes; and
a touch controller electrically connected to the first read-out integrated circuit and the second read-out integrated circuit,
wherein the touch controller is configured to:
in a first communication period, transmit a first serial clock signal, having a signal level change at a first time point to the first read-out integrated circuit to receive a first touch sensing data from the first read-out integrated circuit; and
in the first communication period, transmit a second serial clock signal, not having the signal level change at the first time point, to the second read-out integrated circuit to receive a second touch sensing data from the second read-out integrated circuit.
